(19) United States
(12) Patent Application Publication
(10) Pub. No.: US 2024/0343153 A1
(43) Pub. Date: Oct. 17, 2024

(54) METHOD

(71) Applicant: TOYOTA JIDOSHA KABUSHIKI KAISHA, Toyota-shi (JP)

(72) Inventors: Ryosuke KOBAYASHI, Nagakute-shi (JP); Koichi WATANABE, Setagaya-ku (JP); Motofumi KAMIYA, Nagoya-shi (JP); Masaki NISHINO, Anjo-shi (JP); Jean-Sebastien BOIRE, Yokohama-shi (JP); Takuya NISHIOKA, Nagoya-shi (JP); Yohei NAKANISHI, Nagoya-shi (JP); Masaki MAKIHARA, Okazaki-shi (JP)

(73) Assignee: TOYOTA JIDOSHA KABUSHIKI KAISHA, Toyota-shi (JP)

(21) Appl. No.: 18/617,680

(22) Filed: Mar. 27, 2024

(30) Foreign Application Priority Data
Apr. 17, 2023 (JP) 2023-067443

(51) Int. Cl. B60L 53/68; B60L 53/57; B60L 53/62; G06Q 10/02

(52) U.S. Cl. CPC B60L 53/68; B60L 53/57; B60L 53/62; G06Q 10/02

(57) ABSTRACT

A method performed by an information processing apparatus, the information processing apparatus being used for providing a vehicle charging service that dispatches a power supply vehicle to be used for charging a vehicle to a location designated by a user, includes acquiring information on the user, who is scheduled to stay at a predetermined facility, acquiring a first residual SOC of the vehicle of the user before departure for the predetermined facility, predicting a second residual SOC at a point in time when the vehicle arrives at the predetermined facility, and notifying the user of a proposal to make a reservation for use of the vehicle charging service with using the predetermined facility as a charging point in a case in which the second residual SOC is less than a predetermined standard.

### CROSS-REFERENCE TO RELATED APPLICATION

This application claims priority to Japanese Patent Application No. 2023-067443, filed on Apr. 17, 2023, the entire contents of which are incorporated herein by reference.

### TECHNICAL FIELD

The present disclosure relates to a method.

### BACKGROUND

Technology for providing a vehicle charging service by a rescue electric vehicle when an electric vehicle runs out of electricity is known. For example, Patent Literature (PTL) 1 discloses that a rescue vehicle goes to the position of a vehicle and supplies power.

### CITATION LIST

### Patent Literature

PTL 1: JP 2019-086841 A

### SUMMARY

In a conventional vehicle charging service, a user needs to consider in using a predetermined facility whether to use a vehicle charging service taking into account the state of charge (SOC) of the battery in preparation for the next driving. Thus, there is room for improvement with respect to technology for providing vehicle charging services.

It would be helpful to improve technology for providing vehicle charging services.

A method according to an embodiment of the present disclosure is a method performed by an information processing apparatus, the information processing apparatus being used for providing a vehicle charging service that dispatches a power supply vehicle to be used for charging a vehicle to a location designated by a user, the method including:
acquiring information on the user, who is scheduled to stay at a predetermined facility;
acquiring a first residual SOC of the vehicle of the user before departure for the predetermined facility;
predicting a second residual SOC at a point in time when the vehicle arrives at the predetermined facility; and
proposing to the user a reservation for use of the vehicle charging service with using the predetermined facility as a charging point in a case in which the second residual SOC is less than a predetermined standard.

According to an embodiment of the present disclosure, technology for providing vehicle charging services can be improved.

### BRIEF DESCRIPTION OF THE DRAWINGS

In the accompanying drawings:

FIG. 1 is a diagram illustrating a schematic configuration of a system according to an embodiment of the present disclosure;

FIG. 2 is a block diagram illustrating a schematic configuration of an information processing apparatus;

FIG. 3 is a block diagram illustrating a schematic configuration of a terminal apparatus; and

FIG. 4 is a flowchart illustrating operations of the information processing apparatus according to the present embodiment.

### DETAILED DESCRIPTION

An embodiment of the present disclosure will be described below, with reference to the drawings. In the descriptions of the present embodiment, detailed descriptions of the same or corresponding portions are omitted or simplified, as appropriate.

### Outline of Embodiment

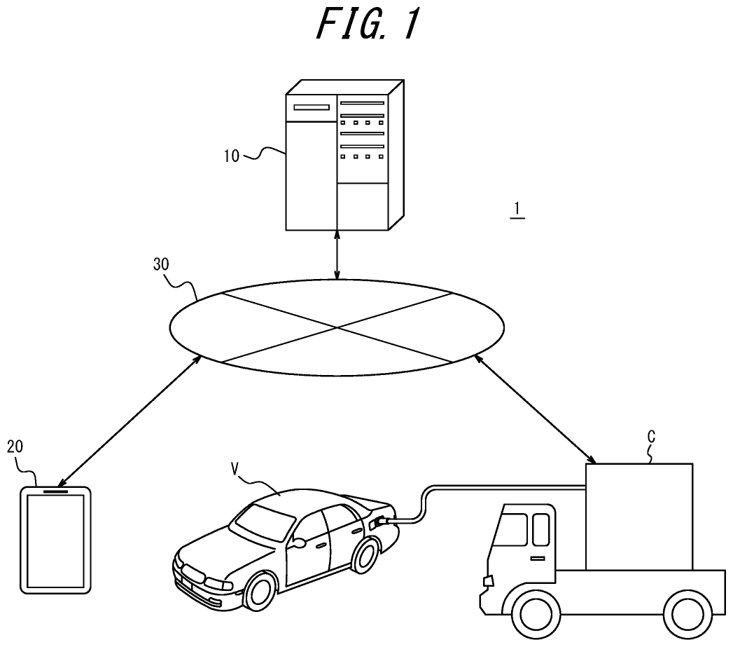

An outline of a system 1 according to an embodiment of the present disclosure will be described with reference to FIG. 1. The system 1 includes an information processing apparatus 10 and a terminal apparatus 20. The information processing apparatus 10 and the terminal apparatus 20 are communicably connected to a network 30 including, for example, the Internet, a mobile communication network, or the like.

The system 1 according to the present embodiment is used for providing so-called rush charging services. Rush charging service is a service in which a power supply vehicle C that receives a request from a user who wishes to charge a vehicle V of the user joins the vehicle V and charges the vehicle V.

The information processing apparatus 10 is, for example, a server apparatus but is not limited to this and may be any appropriate computer. The information processing apparatus 10 can communicate with the terminal apparatus 20 via the network 30.

The terminal apparatus 20 is any computer used by the user. For example, a general purpose computer such as a smartphone or a tablet terminal, or a dedicated computer can be employed as the terminal apparatus 20. Alternatively, the terminal apparatus 20 may be a car navigation system (Automotive navigation system) installed in the vehicle V of the user. For example, the user can use the terminal apparatus 20 to make a reservation for use of a predetermined facility or the vehicle charging service, or to confirm and reply to a notification from the information processing apparatus 10. In the present embodiment, the predetermined facility is described as a hotel, campground, or other facility that involves user lodging, but it may be any facility, not limited to that example.

The network 30 includes the Internet, at least one WAN, at least one MAN, or a combination thereof. The term “WAN” is an abbreviation of wide area network. The term “MAN” is an abbreviation of metropolitan area network. The network 30 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The power supply vehicle C is a power-feeding device with a storage battery that can be installed on the ground to charge the vehicle V, or a vehicle equipped with a storage battery. The power supply vehicle C is an automobile, for example, but is not limited to this and may be any appropriate vehicle. Each of the automobiles is, for example, a Battery Electric Vehicle (BEV), a Hybrid Electric Vehicle (HEV), a Plug-in Hybrid Electric Vehicle (PHEV), a Fuel Cell Electric Vehicle (FCEV), or the like, but is not limited to these. The power supply vehicle C may be operated directly or remotely by the driver. Alternatively, the power supply vehicle C may be capable of automated driving such as any one of Level 1 to Level 5 as defined by the Society of Automotive Engineers (SAE), for example. The system 1 may include any number greater than two of power supply vehicles C. The power supply vehicle C is managed by the operator providing the vehicle charging service. In the present embodiment, the power supply vehicle C is dispatched to the location designated by the user to supply power to the vehicle V.

The vehicle Vis any type of automobile that uses electric power for at least part of its drive, such as a BEV, PHEV, or FCEV. The vehicle V is the vehicle in which the user rides.

First, an outline of the present embodiment will be described, and details thereof will be described later. The information processing apparatus 10 is used for providing a vehicle charging service that dispatches the power supply vehicle C to be used for charging the vehicle V to the location designated by the user. The information processing apparatus 10 acquires information on the user who is scheduled to stay at the predetermined facility, acquires the first residual SOC of the vehicle V of the user before departure for the predetermined facility, predicts the second residual SOC at the point in time when the vehicle V arrives at the predetermined facility, and proposes to the user a reservation for use of the vehicle charging service with using the predetermined facility as the charging point in a case in which the second residual SOC is less than the predetermined standard.

According to the present embodiment, the information processing apparatus 10 acquires the first residual SOC of the vehicle V, predicts the second residual SOC based on the information on the user, and proposes to the user a reservation for use of the vehicle charging service. Thus, the user does not need to plan recharging in consideration of the residual SOC of the vehicle V, which can improve convenience. This will improve the technology for providing vehicle charging services.

Next, configurations of the system 1 will be described in detail.

### (Configuration of Information Processing Apparatus)

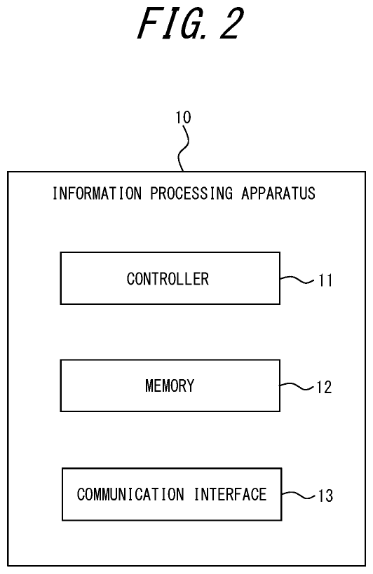

As illustrated in FIG. 2, the information processing apparatus 10 includes a controller 11, a memory 12, and a communication interface 13.

The controller 11 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is, for example, a field-programmable gate array (FPGA), but is not limited to this. The dedicated circuit is an application specific integrated circuit (ASIC), for example, but is not limited to this. The controller 11 controls operations of the entire information processing apparatus 10.

The memory 12 includes one or more memories. The memories are semiconductor memories, magnetic memories, optical memories, or the like, for example, but are not limited to these. The memories included in the memory 12 may each function as, for example, a main memory, an auxiliary memory, or a cache memory. The memory 12 stores any information to be used for operations of the information processing apparatus 10. For example, the memory 12 may store a system program, an application program, embedded software, and the like. The information stored in the memory 12 may be updated with, for example, information acquired from the network 30 via the communication interface 13.

The communication interface 13 includes at least one interface for communication for connecting to the network 30. The interface for communication is compliant with mobile communication standards such as the 4th generation (4G) standard and the 5th generation (5G) standard, a wired local area network (LAN) standard, a wireless LAN standard, or the like, for example, but not limited to these, and may be compliant with any communication standard. In the present embodiment, the information processing apparatus 10 communicates with the terminal apparatus 20 and the power supply vehicle C via the communication interface 13 and the network 30.

### (Configuration of Terminal Apparatus)

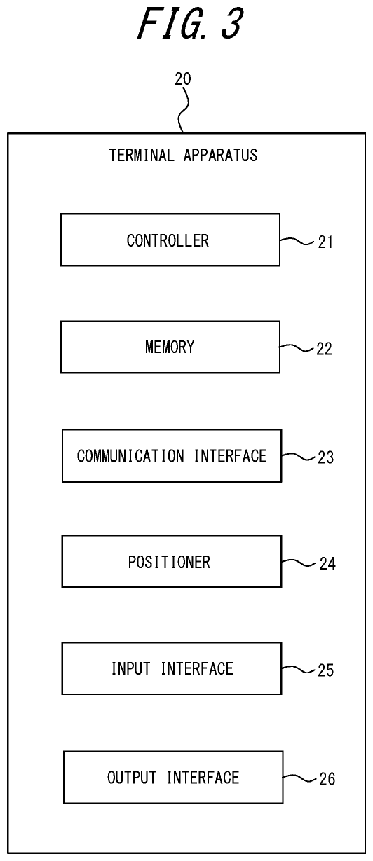

As illustrated in FIG. 3, the terminal apparatus 20 includes a controller 21, a memory 22, a communication interface 23, a positioner 24, an input interface 25, and an output interface 26.

The controller 21 includes at least one processor, at least one programmable circuit, at least one dedicated circuit, or a combination of these. The controller 21 controls operations of the entire terminal apparatus 20.

The memory 22 includes one or more memories. The memories included in the memory 22 may each function as, for example, a main memory, an auxiliary memory, or a cache memory. The memory 22 stores any information to be used for operations of the information processing apparatus 10. For example, the memory 22 may store a system program, an application program, a database, map information, and the like. The information stored in the memory 22 may be updated with, for example, information acquired from the network 30 via the communication interface 23.

The communication interface 23 includes at least one interface for communication for connecting to the network 30. The interface for communication is compliant with, for example, a mobile communication standard, a wired LAN standard, or a wireless LAN standard, but not limited to these, and may be compliant with any communication standard. In the present embodiment, the terminal apparatus 20 communicates with the information processing apparatus 10 via the communication interface 23 and the network 30.

The positioner 24 includes at least one device for acquiring positional information for the terminal apparatus 20. Specifically, the positioner 24 includes a receiver corresponding to the Global Positioning System (GPS), for example, but is not limited to this and may include a receiver corresponding to any satellite positioning system. If the terminal apparatus 20 is a car navigation system installed in a vehicle V, the positional information for the terminal apparatus 20 may be treated as the positional information for the vehicle V.

The input interface 25 may include at least one input device for detecting user input. The input device is a physical key, a capacitive key, a touch screen integrally provided with a display, a microphone for accepting audio input, a camera, or the like, for example, but is not limited to these. The input interface 25 may include an interface for connecting to an external input device.

The output interface 26 may include at least one output device for outputting information to notify the user of the information. The output device is a display for outputting information as video, a speaker for outputting information as audio, or the like, for example, but is not limited to these. The output interface 26 may include an interface for connecting to an external output device.

### (Flow of Operations of Information Processing Apparatus)

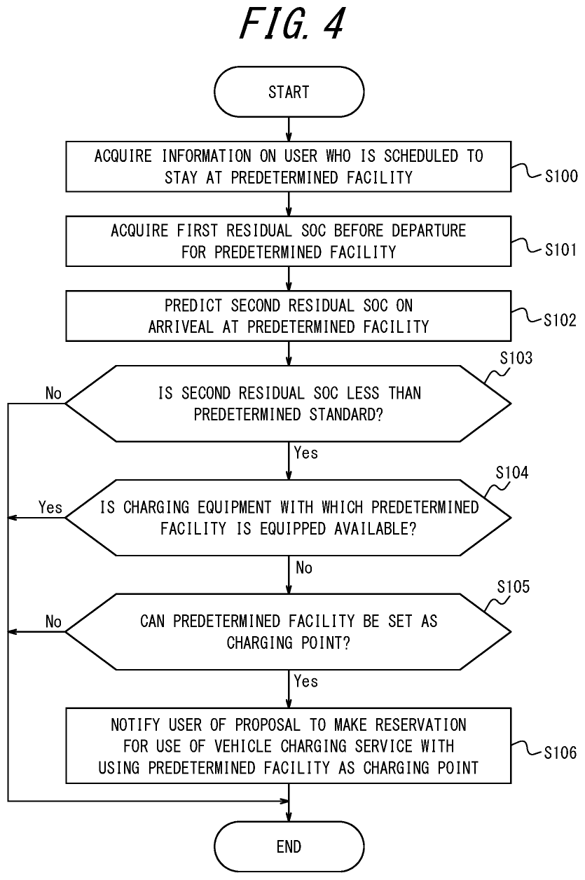

Operations of the information processing apparatus 10 according to the present embodiment will be described with reference to FIG. 4. These operations correspond to a method according to the present embodiment. The information processing apparatus 10 is described below as transmitting and receiving information to and from each apparatus via the communication interface 13 and the network 30.

Step S100: The controller 11 of the information processing apparatus 10 acquires information on the user who is scheduled to stay at the predetermined facility.

In the present embodiment, for example, the user of the vehicle V operates the terminal apparatus 20 to make a reservation for a predetermined facility. The controller 11 of the information processing apparatus 10 acquires the information on the user from the terminal apparatus 20 via the network 30. The information on the user includes any information regarding the individual user, information on a reservation for use of a predetermined facility, information on a schedule during a stay at a predetermined facility, or information regarding the vehicle V used by the user (vehicle type, year). The information on the schedule during the stay at the predetermined facility includes information on a schedule of the outbound and inbound schedule information to and from the predetermined facility.

The timing for acquiring the information on the user is, for example, at the time of making a reservation at a predetermined facility, but may be any timing. The information, once acquired, may be updatable by the user.

Step S101: The controller 11 acquires the first residual SOC of the vehicle V of the user before departure for a predetermined facility.

Any method can be employed to acquire the first residual SOC. For example, the controller 11 may acquire the first residual SOC automatically or the user may transmit it manually using the terminal apparatus 20.

The timing for acquiring the first residual SOC is, for example, the night before or the morning of the departure date indicated in the information on the reservation for use or information on the schedule but may be any timing.

Step S102: The controller 11 predicts the second residual SOC at the point in time when the vehicle V arrives at the predetermined facility.

In the present embodiment, the controller 11 predicts the second residual SOC at the point in time when the user arrives at the predetermined facility from the information regarding the vehicle V of the user, the information on the schedule for the onward journey to the predetermined facility, and the acquired first residual SOC. For example, the controller 11 calculates the route (mileage) to a predetermined facility based on the information on the schedule for the onward trip to the predetermined facility, and calculates fuel consumption, etc. based on the information regarding the vehicle V. The controller 11 then calculates the SOC that the vehicle V consumes on the outbound route based on these pieces of information and predicts the second residual SOC by subtracting it from the acquired first residual SOC. In addition to this, the controller 11 may predict the second residual SOC using any information such as traffic congestion or weather information on the day of departure.

Step S103: The controller 11 determines whether the second residual SOC predicted in step S102 above is less than the predetermined standard. When determined to be equal to or greater than the predetermined standard (step S103—No), the process ends. On the other hand, when determined to be less than the predetermined standard (S103—Yes), the process advances to S104.

The predetermined standard may be a fixed value or may be automatically determined by the controller 11. When the predetermined standard is automatically determined by the controller 11, for example, the controller 11 calculates the route (mileage) based on the information on the schedule during the stay at the predetermined facility included in the information on the user acquired in step S100, and calculates the fuel consumption, etc. based on the information regarding the vehicle V. The controller 11 then predicts the consumed SOC based on these pieces of information and uses the consumed SOC as the predetermined standard.

Step S104: The controller 11 determines whether or not charging equipment with which the predetermined facility is equipped is available. When it is determined that charging equipment is available (step S104—Yes), the process ends. On the other hand, when it is determined that no charging equipment is available (S104—No), the process advances to S105.

Any method can be used to determine whether charging equipment with which the predetermined facility is equipped is available. For example, if the controller 11 acquires information indicating that charging equipment with which the predetermined facility is equipped is available, it determines that charging equipment is available. The information indicating whether or not equipped charging equipment is available may be acquired in advance by the controller 11, or may be acquired at any time during steps S101-S104. The controller 11 may acquire the information indicating whether or not equipped charging equipment is available, for example, from an external server via the Internet, or it may acquire such information from the terminal apparatus 20, which is entered into the terminal apparatus 20 by the user. The information indicating whether or not equipped charging equipment is available may be acquired automatically by the controller 11, or it may be transmitted manually by the user from the terminal apparatus 20 or other devices.

If it is determined that equipped charging facility is available, the controller 11 may notify the user via the terminal apparatus 20 of information regarding the equipped charging equipment.

Step S105: The controller 11 determines whether the predetermined facility can be set as a charging point. When determined not to be able to be set (step S105—No), the process ends. When determined to be able to be set (S105—Yes), the process advances to S106.

Setting a predetermined facility as a charging point means designating the premises of a predetermined facility or a nearby parking lot, etc., as a location where the vehicle charging services are provided. Any method can be used to determine whether the predetermined facility can be set as the charging point. For example, if the controller 11 acquires information indicating that the predetermined facility can be set as a charging point, it determines that the predetermined facility can be set as a charging point. The information indicating whether or not the predetermined facility can be set as the charging point may be acquired in advance by the controller 11 or at any timing in steps S101-S104. The controller 11 may also acquire information indicating whether or not the predetermined facility can be set as a charging point, for example, from an external server via the Internet, or it may acquire such information entered into the terminal apparatus 20 by the user from the terminal apparatus 20. The information indicating whether or not the predetermined facility can be set as a charging point may be acquired automatically by the controller 11 or manually transmitted by the user from the terminal apparatus 20 or other devices.

If it is determined that the setting is not possible, the controller 11 may notify the user via the terminal apparatus 20 of information regarding charging equipment in the vicinity of the predetermined facility.

Step S106: The controller 11 proposes to the user a reservation for use of the vehicle charging service with using the predetermined facility as the charging point.

Any appropriate method can be adopted to notify the user. For example, the controller 11 may notify the user by displaying a screen on the output interface 26 of the terminal apparatus 20 that prompts the user to make a reservation for use of the vehicle charging service. The timing of notification may be at any time prior to arrival at the predetermined facility.

When the user selects to make a reservation for use of the vehicle charging service, the controller 11 dispatches the power supply vehicle C to the location designated by the user.

As described above, the information processing apparatus 10 is used for providing a vehicle charging service that dispatches the power supply vehicle C to be used for charging the vehicle V to the location designated by the user. The information processing apparatus 10 acquires information on the user who is scheduled to stay at the predetermined facility, acquires the first residual SOC of the vehicle V of the user before departure for the predetermined facility, predicts the second residual SOC at the point in time when the vehicle V arrives at the predetermined facility, and proposes to the user a reservation for use of the vehicle charging service with using the predetermined facility as the charging point in a case in which the second residual SOC is less than the predetermined standard.

According to such a configuration, the information processing apparatus 10 acquires the first residual SOC of the vehicle V, predicts the second residual SOC based on the information on the user, and proposes to the user a reservation for use of the vehicle charging service. Thus, the user does not need to plan recharging in consideration of the residual SOC of the vehicle V, which can improve convenience. This will improve the technology for providing the vehicle charging services.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, the configuration and operations of the information processing apparatus 10 in the above embodiment may be distributed to multiple computers capable of communicating with each other. An embodiment in which some or all of the components of the information processing apparatus 10 are provided in the terminal apparatus 20 can also be implemented.

In the embodiment described above, the operation flow of the information processing apparatus 10 was divided into steps S100-S106. However, embodiments in which some of the steps are performed together or some of the steps are omitted are also possible. For example, the operations in steps S104-S105 may be omitted.

In the embodiment described above, the information on the user may include information on a schedule of the user during a stay at a predetermined facility. The controller 11 may also use the information on the schedule to predict a time period when the vehicle V is parked at the predetermined facility. The controller 11 may then decide to supply power to the vehicle V of the user during the time period when the vehicle V is parked in a parking lot or other location at the predetermined facility (e.g., at night). In such a case, the controller 11 dispatches the power supply vehicle C to the location designated by the user during the time period when the vehicle V is parked. This allows charging to be completed while the user is not using the vehicle V.

For example, an embodiment in which a general purpose computer functions as the information processing apparatus 10 according to the above embodiment can also be implemented. Specifically, a program in which processes for realizing the functions of the information processing apparatus 10 according to the above embodiment are written may be stored in a memory of a general purpose computer, and the program may be read and executed by a processor. Accordingly, the present disclosure can also be implemented as a program executable by a processor, or a non-transitory computer readable medium storing the program.

In the embodiment described above, the power supply vehicle C may be an automatic vehicle that does not require operation by a driver. In such a case, the controller 11 of the information processing apparatus 10 may control the automatic operation of each power supply vehicle C by sending instructions to each power supply vehicle C to operate in accordance with the determined operation plan.

1. A method performed by an information processing apparatus, the information processing apparatus being used for providing a vehicle charging service that dispatches a power supply vehicle to be used for charging a vehicle to a location designated by a user, the method comprising:
acquiring information on the user, who is scheduled to stay at a predetermined facility;
acquiring a first residual SOC of the vehicle of the user before departure for the predetermined facility;
predicting a second residual SOC at a point in time when the vehicle arrives at the predetermined facility; and
notifying the user of a proposal to make a reservation for use of the vehicle charging service with using the predetermined facility as a charging point in a case in which the second residual SOC is less than a predetermined standard.

2. The method according to claim 1, wherein the information processing apparatus is configured to notify the user of the proposal to make a reservation for use of the vehicle charging service based on information that the predetermined facility can be set as a charging point.

3. The method according to claim 1, further comprising acquiring information regarding charging equipment with which the predetermined facility is equipped, wherein
the information processing apparatus is configured to notify the user of the proposal to make a reservation for use of the vehicle charging service in a case in which no charging equipment is available.

4. The method according to claim 1, wherein
the information on the user includes information on a schedule of the user during a stay at the predetermined facility,
the method further comprises predicting a consumed SOC during the stay at the predetermined facility based on the information on the schedule, and
the information processing apparatus is configured to notify the user of the proposal to make a reservation for use of the vehicle charging service in a case in which the second residual SOC is less than the consumed SOC.

5. The method according to claim 1, wherein
the information on the user includes information on a schedule of the user during a stay at the predetermined facility,
the method further comprises predicting a time period when the vehicle is parked at the predetermined facility based on the information on the schedule, and
the information processing apparatus is configured to determine that power is to be supplied to the vehicle of the user during the time period when the vehicle is parked.
